(19) United States
(12) Patent Application Publication
(10) Pub. No.: US 2026/0088838 A1
(43) Pub. Date: Mar. 26, 2026

(54) THERMAL DEFINED RADIO

(71) Applicant: QUALCOMM Incorporated, San Diego, CA (US)

(72) Inventors: Alexander DOROSENCO, El Cajon, CA (US); Guy KLEMENS, San Diego, CA (US); Andrew ARNETT, San Diego, CA (US); Dylan BERGHEIMER, Oceanside, CA (US); Clayton DUMSTORFF, San Diego, CA (US)

(21) Appl. No.: 18/894,693

(22) Filed: Sep. 24, 2024

(51) Int. Cl. H04B 1/036; G06F 1/20; H01Q 1/02; H04B 1/18

(52) U.S. Cl. CPC H04B 1/036; G06F 1/206; H01Q 1/02; H04B 1/18

(57) ABSTRACT

Certain aspects of the present disclosure provide techniques for thermal management for certain high frequency communications. An example method of wireless communications includes obtaining a first indication of a plurality of temperatures derived from at least one or more measurements obtained at a first time occasion, wherein the plurality of temperatures are associated with a plurality of components of one or more transmitter circuits. The method further includes performing one or more first actions in response to a first temperature of the plurality of temperatures being greater than or equal to a first temperature threshold, wherein the first temperature is associated with a first subset of the plurality of components.

### INTRODUCTION

### Field of the Disclosure

Aspects of the present disclosure relate to wireless communications, and more particularly, to thermal management, such as for certain high frequency communications, such as sub-terahertz frequencies above 90 gigahertz.

### Description of Related Art

Wireless communications systems are widely deployed to provide various telecommunication services such as telephony, video, data, messaging, broadcasts, etc. These wireless communications systems may employ multiple-access technologies capable of supporting communications with multiple users by sharing available wireless communications system resources with those users. Wireless communication devices may communicate RF signals via any of various suitable radio access technologies (RATs) including, but not limited to, 5G New Radio (NR), Evolved Universal Terrestrial Radio Access (E-UTRA), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., Institute of Electrical and Electronics Engineers (IEEE) 802.11 specifications), any future RAT, and/or the like.

In certain cases, a wireless communications device is equipped with a radio frequency (RF) transceiver (also referred to as an RF front-end) for communicating RF signals. In general, a baseband signal is modulated to convey information using a modulation technique, such as phase-shift keying (PSK) or any other suitable modulation technique. In a transmit mode, the RF transceiver is responsible for multiplexing the baseband signal with an RF carrier signal that is transmitted over the air (e.g., a wireless communication channel). Such an operation is called upconversion. In a receive mode, the RF transceiver converts a received RF signal to the baseband signal. Such an operation is called downconversion. The received baseband signal then can be demodulated into the information encoded at a transmitter. The RF transceiver may include a cascade of components in a transmit chain and a receive chain, respectively. The cascade of components may include, for example, one or more of attenuators, switches, couplers, filters, mixers, amplifiers, frequency synthesizers, oscillators, antenna tuners, duplexers, diplexers, detectors, etc.

Although there have been great technological advancements in RF circuitry over many years, challenges still exist. For example, RF circuitry can still encounter a threshold operating temperature beyond which the RF circuitry may no longer function, such as a junction temperature for semiconductor devices. Accordingly, there is a continuous desire to improve the technical performance of RF circuitry through thermal management.

### SUMMARY

Some aspects provide an apparatus configured for wireless communications. The apparatus includes one or more transmitter circuits configured to output a signal for transmission, wherein the one or more transmitter circuits comprise a plurality of components. The apparatus includes one or more circuits configured to cause the apparatus to obtain a first indication of a plurality of temperatures derived from at least one or more measurements obtained at a first time occasion, wherein the plurality of temperatures are associated with the plurality of components; and perform one or more first actions in response to a first temperature of the plurality of temperatures being greater than or equal to a first temperature threshold, wherein the first temperature is associated with a first subset of the plurality of components.

Some aspects provide an apparatus configured for wireless communications. The apparatus includes one or more transmitter circuits configured to output at least one signal for transmission, wherein the one or more transmitter circuits comprise a plurality of components. The apparatus includes one or more processors coupled to the one or more transmitter circuits, the one or more processors being configured to cause the apparatus to obtain, for each of the plurality of components, an indication of whether a respective component is available for transmission based at least in part on a temperature associated with the respective component; and output the signal via a set of the plurality of components available for transmission.

Some aspects provide a method for wireless communications by an apparatus. The method includes obtaining a first indication of a plurality of temperatures derived from at least one or more measurements obtained at a first time occasion, wherein the plurality of temperatures are associated with a plurality of components of one or more transmitter circuits. The method further includes performing one or more first actions in response to a first temperature of the plurality of temperatures being greater than or equal to a first temperature threshold, wherein the first temperature is associated with a first subset of the plurality of components.

Some aspects provide a method for wireless communications by an apparatus. The method includes obtaining, for each of a plurality of components of one or more transmitter circuits, an indication of whether a respective component is available for transmission based at least in part on a temperature associated with the respective component. The method further includes outputting a signal via a set of the plurality of components available for transmission.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 depicts an example wireless communications system.

FIG. 2 depicts an example wireless communications device communicating with another device.

FIG. 3A depicts an example thermal management architecture for a wireless communications device.

FIG. 3B depicts another example thermal management architecture for a wireless communications device.

FIG. 4 depicts an example radio frequency integrated circuit (RFIC) coupled to an antenna array.

FIG. 5 depicts an example method for wireless communications by an apparatus.

FIG. 6 depicts an example method for wireless communications by an apparatus.

FIG. 7 depicts a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums for thermal management, such as for certain high frequency communications, such as sub-terahertz frequencies above 90 gigahertz. Though certain aspects of techniques are discussed with respect to thermal management for high frequency communications, it should be noted that the techniques discussed herein may be used similarly for thermal management for communications in other frequency ranges or bands.

As there is a continuous desire to improve the technical performance of wireless communication systems (such as increased data rates and/or reduced latencies), wireless communication devices are being developed that can communicate in sub-terahertz (sub-THz) frequencies. In certain cases, sub-THz frequencies may refer to, for example, frequencies of 90 to 300 gigahertz (GHz) or frequencies above 90 GHz and below 1 THz. As an example, sub-THz communications may enable data rates greater than 100 gigabits per second (Gbps). In certain cases, sub-THz communications may enable wireless communications in data centers, immersive extended reality (such as holographic communication), and/or massive internet-of-things (IoT) deployments.

Technical problems for sub-THz communications include, for example, effective thermal management of a sub-THz transmitter (e.g., a transmitter capable of outputting a signal at a sub-THz frequency). Certain wireless devices have shown reduced power efficiency for signal transmission at frequencies above 100 GHz compared to transmissions at lower frequencies. Moreover, this power efficiency along with higher output power used to overcome the path losses of sub-THz communications may result in significantly higher power dissipation and heating for wireless devices capable of sub-THz transmissions. For example, certain component(s) of a sub-THz transmitter (such as power amplifiers) have exhibited temperatures that exceed transistor junction limits (e.g., greater than 200° Celsius) while operating at a peak output power and/or a maximum transmit duty cycle. In certain cases, thermal dissipation techniques (e.g., heat sinks, fans, liquid cooling systems, or the like) may be used to reduce the operating temperature of a sub-THz transmitter. However, certain thermal dissipation techniques may not be suitable for certain wireless devices, such as portable devices with small form factors including cellular phones, wearable devices (e.g., an extended reality headset or glasses), IoT devices, or the like.

Certain aspects described herein may overcome the aforementioned technical problem(s), for example, by providing thermal management, such as for high frequency communications including sub-THz communications. In certain aspects, a wireless device may monitor the temperatures of components of a transmitter (such as power amplifiers and/or transmitter circuits) over time and perform techniques to prevent the components from overheating. As an example, the wireless device may reduce the transmit power, adjust the transmit duty cycle, and/or re-allocate the antenna elements used for a transmission based on the temperature(s) of such components. In certain aspects, a wireless device may employ a sensor hub that obtains temperature measurements of components of a transmitter and provides an indication of the temperatures to a modem, which may then determine which components can be used for transmission based on the respective temperatures. In certain aspects, a transmitter circuit may determine which components of the transmitter circuit can be used for transmission, and the transmitter may notify the modem of such components. Then, the modem may control the transmission (e.g., transmit power, transmit duty cycle, and/or beamforming) based on the components available for transmission.

Certain techniques for thermal management described herein may provide various beneficial technical effects and/or advantages. The techniques for thermal management may enable reliable data rates, reliable latencies, and/or increased operating life of a wireless device. The reliable data rates and/or latencies may be attributable to the wireless device cycling through a subset of components over time for transmission, maintaining a suitable transmit power, and/or maintaining a suitable transmit duty cycle for communications. As an example, the wireless device may refrain from using a subset of components for transmission to allow such components to dissipate heat. In certain cases, the increased operating life of the wireless device may be attributable to preventing certain components from overheating that leads to electrical failures.

### Example Wireless Communications System

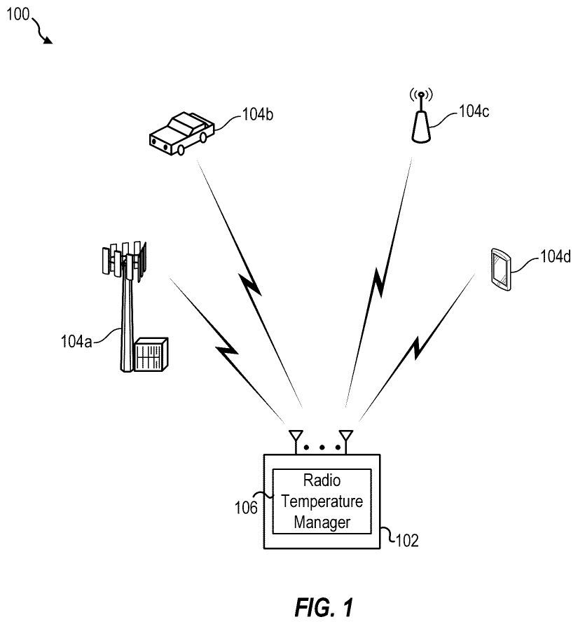

FIG. 1 illustrates an example wireless communications system 100 in which aspects of the present disclosure may be performed. For example, the wireless communications system 100 may include a wireless wide area network (WWAN) and/or a wireless local area network (WLAN). A WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G) or Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communications system 100 may include a device-to-device (D2D) communications network or a short-range communications system, such as Bluetooth communications or near field communications (NFC).

As illustrated in FIG. 1, the wireless communications system 100 may include a first wireless device 102 communicating with any of various second wireless devices 104a-d (hereinafter “the second wireless device 104”) via any of various radio access technologies (RATs), where a wireless device may refer to a wireless communications device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), D2D communications, etc.

The first wireless device 102 may include any of various wireless communications devices including a user equipment (UE), a base station, a wireless station, an access point, customer-premises equipment (CPE), etc. In certain aspects, the first wireless device 102 includes a radio temperature manager 106 that controls transmission of a signal based on the operating temperature of components of transmitter circuit(s), in accordance with aspects of the present disclosure.

The second wireless device 104 may include, for example, a base station 104a, a vehicle 104b, an access point (AP) 104c, and/or a UE 104d. Further, the wireless communications systems 100 may include terrestrial aspects, such as ground-based network entities (e.g., the base station 104a and/or access point 104c), and/or non-terrestrial aspects, such as a spaceborne platform and/or an aerial platform, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104d may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

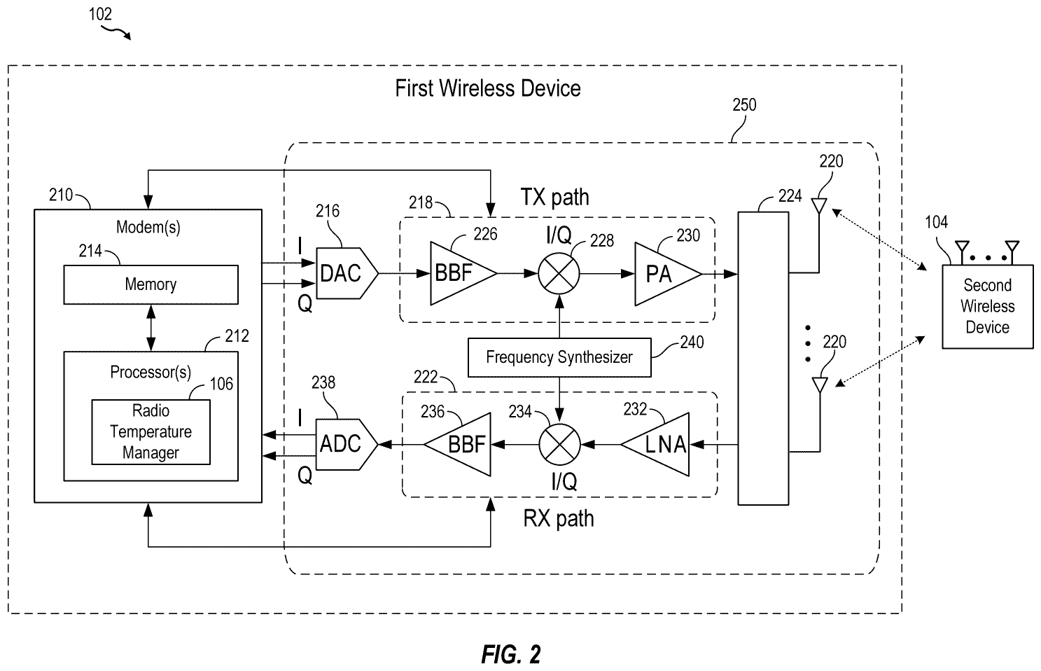

FIG. 2 illustrates example components of the first wireless device 102, which may be used to communicate with any of the second wireless devices 104.

The first wireless device 102 may be, or may include, a chip, system on chip (SoC), system in package (SiP), chipset, package, device that includes one or more modems 210 (hereinafter “the modem 210”). In some cases, the modem 210 may include, for example, any of a WWAN modem (e.g., a modem configured to communicate via E-UTRA 5G NR, and/or any future WWAN communications standards), a WLAN modem (e.g., a modem configured to communicate via IEEE 802.11 standards), a Bluetooth modem, a NTN modem, etc. In certain aspects, the first wireless device 102 also includes one or more RF transceivers (hereinafter “the RF transceiver 250”). In some cases, the RF transceiver 250 may be referred to as an RF front end (RFFE). In some aspects, the modem 210 further includes one or more processors, processing blocks or processing elements (hereinafter “the processor 212”) and one or more memory blocks or elements (hereinafter “the memory 214”). In some cases, the processor 212 may implement and/or include the radio temperature manager 106. In certain aspects, the processor 212 and/or the memory 214 are implemented external or otherwise separate from the modem 210.

In certain aspects, the processor 212 may process any of certain protocol stack layers associated with a radio access technology (RAT). For example, the processor 212 may process any of an application layer, packet layer, WLAN protocol stack layers (e.g., a link or a medium access control (MAC) layer), and/or WWAN protocol stack layers (e.g., a radio resource control (RRC) layer, a packet data convergence protocol (PDCP) layer, a radio link control (RLC) layer, and a MAC layer).

The modem 210 may generally be configured to implement a physical (PHY) layer. For example, the modem 210 may be configured to modulate packets and to output the modulated packets to the RF transceiver 250 for transmission over a wireless medium. The modem 210 is similarly configured to obtain modulated packets received by the RF transceiver 250 and to demodulate the packets to provide demodulated packets. In addition to a modulator and a demodulator, the modem 210 may further include digital signal processing (DSP) circuitry, automatic gain control (AGC), a coder, a decoder, a multiplexer, and/or a demultiplexer (not shown).

As an example, while in a transmission mode, the modem 210 may obtain data from a data source, such as an application processor. The data may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 216. In certain aspects involving beamforming, the modulated symbols in the respective spatial streams may be precoded via a steering matrix prior to provision to the IFFT block.

The modem 210 may be coupled to the RF transceiver 250 by a transmit (TX) path 218 (also known as a transmit chain) for transmitting signals via one or more antennas 220 (hereinafter “the antennas 220”) and a receive (RX) path 222 (also known as a receive chain) for receiving signals via the antennas 220. When the TX path 218 and the RX path 222 share the antennas 220, the paths may be coupled to the antennas 220 via an interface 224, which may include any of various suitable RF devices, such as a balun, a transformer, an antenna tuner, a switch, a duplexer, a diplexer, a multiplexer, or the like. As an example, the modem 210 may output digital in-phase (I) and/or quadrature (Q) baseband signals representative of the respective symbols to the DAC 216. In some examples, all or most of the elements illustrated as being included in the RF transceiver 250 are implemented in a single chip or die. For example, in some configurations, all of the elements of the RF transceiver except the antennas 220 are implemented on a single chip. In some other configurations, the interface 224 or a portion thereof is also omitted from the single chip.

Receiving I or Q baseband analog signals from the DAC 216, the TX path 218 may include a baseband filter (BBF) 226, a mixer 228 (which may include one or several mixers), and a power amplifier (PA) 230. The BBF 226 filters the baseband signals received from the DAC 216, and the mixer 227 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 228 are typically RF signals, which may be amplified by the PA 230 before transmission by the antennas 220. The antennas 220 may emit RF signals, which may be received at the second wireless device 104. While one mixer 228 is illustrated, several mixers may be used to upconvert the filtered baseband signals to one or more intermediate frequencies and to thereafter upconvert the intermediate frequency signals to a frequency for transmission.

The RX path 222 may include a low noise amplifier (LNA) 232, a mixer 234 (which may include one or several mixers), and a baseband filter (BBF) 236. RF signals received via the antennas 220 (e.g., from the second wireless device 104) may be amplified by the LNA 232, and the mixer 234 mixes the amplified RF signals with a receive local oscillator (LO) signal to convert the RF signal to a baseband frequency (e.g., downconvert). The baseband signals output by the mixer 234 may be filtered by the BBF 236 before being converted by an analog-to-digital converter (ADC) 238 to digital I or Q signals for digital signal processing. The modem 210 may receive the digital I or Q signals and further process the digital signals, for example, demodulating the digital signals into information.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 240, which may be buffered or amplified by an amplifier (not shown) before being mixed with the baseband signals in the mixer 228. Similarly, the receive LO frequency may be produced by the frequency synthesizer 240, which may be buffered or amplified by an amplifier (not shown) before being mixed with the RF signals in the mixer 234. Separate frequency synthesizers may be used for the TX path 218 and the RX path 222.

While in a reception mode, the modem 210 may obtain digitally converted signals via the ADC 238 and RX path 222. As an example, in the modem 210, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 212) for processing, evaluation, or interpretation.

The modem 210 and/or processor 212 may control the transmission of signals via the TX path 218 and/or reception of signals via the RX path 222. In some aspects, the modem 210 and/or processor 212 may be configured to perform various operations, such as those associated with any of the methods described herein. The modem 210 and/or processor 212 may include a microcontroller, a microprocessor, an application processor, a baseband processor, a MAC processor, an artificial intelligence (AI) processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 214 may store data and program codes (e.g., processor-readable instructions) for performing wireless communications as described herein. In some cases, the memory 214 may be external to the modem 210 and/or processor 212 and/or incorporated therein (as illustrated with the memory 214 or being incorporated with the processor 212).

In certain cases, the first wireless device 102 may exhibit or be configured with a transmit duty cycle for wireless communications. A transmit duty cycle may be indicative of a share (e.g., 100 ms) of a specific period (e.g., 500 ms) in which a wireless device transmits RF signals. The transmit duty cycle may be a ratio of the share to the specific period (e.g., 100 ms/500 ms), where the transmit duty cycle may be represented as a number from zero to one. The transmit duty cycle may be an effective duty cycle associated with a total transmit time of one or more transmissions in the time period, where the one or more transmissions may include bursts of transmissions having a gap of time positioned between at least two of the bursts in the time period. In certain cases, the transmit duty cycle may be standardized (e.g., predetermined or preconfigured) with a specific RAT and/or vary over time, for example, due to changes in radio conditions, mobility, and/or user behavior.

As an example, certain RATs may specify an uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of or represents the transmit duty cycle. In certain aspects, the transmit duty cycle may correspond to the actual duration for past transmissions communicated, for example, within the TDD UL-DL slot pattern. For example, although the wireless device may be configured with a TDD UL-DL slot pattern, the wireless device may use a portion or subset of the UL slots for transmission of RF signals. Thus, the transmit duty cycle for the wireless device may be less than the maximum available duty cycle corresponding to the TDD UL-DL slot pattern.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example Thermal Defined Radio

Aspects of the present disclosure provide thermal management, such as for high frequency communications including sub-THz communications. The thermal management described herein may enable reliable data rates, reliable latencies, and/or increased operating life of a wireless device.

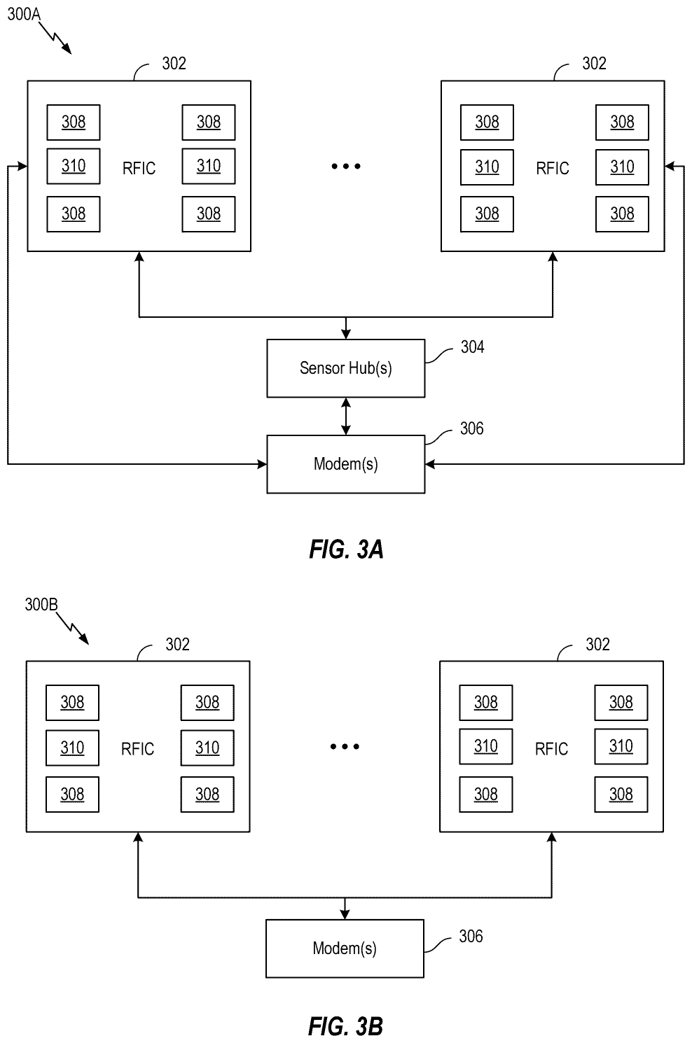

FIG. 3A depicts an example thermal management architecture 300A for a wireless communications device, such as the first wireless device 102 of FIGS. 1 and 2. In this example, the architecture 300A may include one or more transmitter circuits 302, one or more sensor hubs (hereinafter “the sensor hub 304”), and one or more modems (hereinafter “the modem 306”). The modem 306 may be an example of the modem 210 and/or the processor 212 of FIG. 2. In certain aspects, the modem 306 may include a radio temperature manager (e.g., the radio temperature manager 106) that controls the operations of certain circuitry based on the temperature as further described herein. A wireless device (such as the first wireless device 102) may implement or include the architecture 300A for wireless communications.

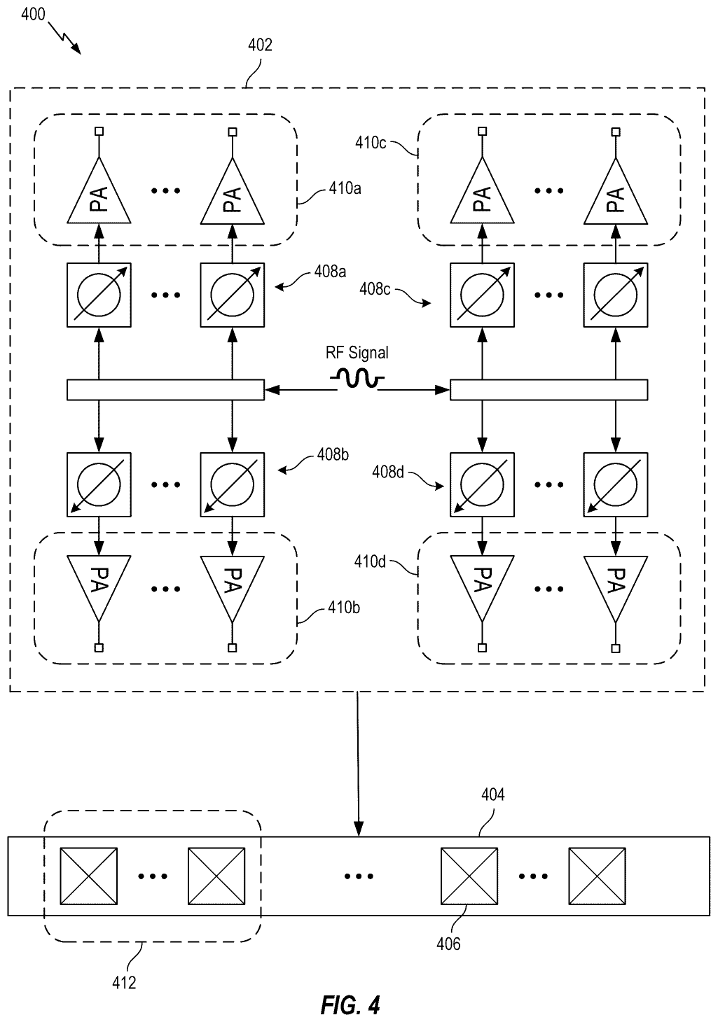

The transmitter circuit(s) 302 may be or include a transmit chain or a portion thereof. The transmitter circuit(s) 302 may be coupled to the sensor hub 304 and the modem 306. The transmitter circuit(s) 302 may support high frequency wireless communications, such as sub-THz communications above 90 GHz. As an example, the transmitter circuit(s) 302 may be configured to output a signal for transmission in a sub-THz frequency band above 90 GHz. The transmitter circuit(s) 302 may include a plurality of components 308 that may encounter a threshold operating temperature without thermal management as described herein. Accordingly, the techniques for thermal management may enable operation of the components 308 or a subset thereof without exceeding a threshold operating temperature beyond which a respective component may fail or encounter performance degradation(s), such as signal distortions, adjacent channel leakage, or the like. The plurality of components 308 may include one or more arrays of power amplifiers as further described herein with respect to FIG. 4. As an example, each of the transmitter circuit(s) 302 may include a set of the components 308, which may form an array of amplifiers.

In certain cases, the transmitter circuits(s) 302 may be or include one or more radio frequency integrated circuits (RFICs) or transceiver circuit packages. As an example, the transmitter circuit(s) 302 may be example(s) of one or more transceiver circuits (such as the RF transceiver 250 of FIG. 2). Each of the RFICs (or transceiver circuit packages) may form a different transmit chain coupled to one or more antenna arrays (not shown), for example, as further described herein with respect to FIG. 4.

The sensor hub 304 may be coupled between the transmitter circuit(s) 302 and the modem 306. The sensor hub 304 may be or include a circuit that enables multiple sensors 310 of the transmitter circuit(s) 302 to communicate with the modem 306. In certain aspects, the sensor hub 304 may be or include a processor coupled between the sensors of the transmitter circuit(s) 302 and the modem 306. In certain aspects, the sensor hub 304 may be or include a microcontroller, a microprocessor, an ASIC, an FPGA, discrete gate or transistor logic, discrete hardware components, or any combination thereof. In certain cases, the sensor hub 304 may include memory to store and/or buffer the sensor data obtained from the sensors 310 of the transmitter circuit(s) 302. The sensor hub 304 may aggregate the sensor data output by the sensors 310 into temperature information, which may be accessible by the modem 306. The temperature information may include a plurality of temperatures associated with the components 308.

The sensor hub 304 may effectively connect multiple sensors 310 (e.g., temperature sensors) of the transmitter circuit(s) 302 and/or the plurality of components 308 to the modem 306 for communication of temperature information and/or thermal management information. In certain cases, the sensor hub 304 may obtain an indication of a plurality of temperatures derived from one or more measurements obtained at a first time occasion. For example, obtaining the measurement(s) at the first time occasion may involve obtaining a plurality of measurements for different components within a threshold time of each other or within a particular time window. The sensor hub 304 may obtain the indication of the plurality of temperatures periodically and/or at varying time intervals to facilitate continuous (e.g., periodic or dynamic) thermal management of the transmitter circuit(s) 302 over time. As an example, the sensor hub 304 may obtain the indication of the plurality of temperatures derived from one or more measurements obtained at a second time occasion, which may occur in time before or after the first time occasion. In certain cases, a time period between the first time occasion and the second time occasion may form a periodicity by which the sensor hub 304 obtains the indication of the plurality of temperatures over time.

In certain cases, an indication of a temperature associated with one or more components 308 may be or include certain operating condition(s) that are indicative of an operating temperature (such as a transmit power, voltage, current, gain, and/or the like), for example, due to the operating temperature being proportional to the operating condition. In certain cases, an indication of a temperature associated with one or more components 308 may be or include a temperature statistic (or statistical temperature), such as an average operating temperature over a moving or running time window, a median operating temperature over the moving time window, a peak operating temperature over the moving time window, a minimum operating temperature over the moving time window, and/or the like. The first time occasion and the second time occasion may correspond to separate instances of the moving time window.

In certain aspects, the sensor hub 304 may provide, to the modem 306, an indication of one or more first action(s) to perform in response to a temperature (e.g., an instantaneous temperature or statistical temperature) associated with a subset of the components 308 being greater than (or equal to) a temperature threshold. The temperature threshold may be or include the threshold operating temperature or a preliminary threshold lower than the threshold operating temperature to prevent or mitigate the threshold operating temperature from being encountered.

The first actions(s) may prevent or mitigate the subset of components 308 from exceeding the threshold operating temperature. Such thermal management may enable reliable data rates, reliable latencies, and/or increased operating life of the transmitter circuit(s) 302. The modem 306 may perform the first action(s) based on the indication obtained from the sensor hub 304. As an example, performing the first action(s) may include reducing or decreasing a transmit power applied to the subset of components 308. In certain cases, performing the first action(s) may include adjusting a transmit duty cycle applied to the subset of components 308. For example, the modem 306 may reduce the overall transmission time used within a time period of the transmit duty cycle.

In certain cases, performing the first action(s) may include reallocating the antenna elements of an antenna array used for beamforming or refraining from using the subset of components 308 for transmission. For example, the subset of components 308 (which exhibit the temperature greater than or equal to the temperature threshold) may include a subset of power amplifiers of an array of power amplifiers used for beamformed transmissions. The array of power amplifiers may feed, to the antenna elements, an RF signal with a specific set of gains and/or phases applied to the antenna elements. When the subset of power amplifiers exhibit a temperature greater than the temperature threshold, the modem 306 may refrain from using the subset of power amplifiers and corresponding subset of the antenna elements for a beamformed transmission. The modem 306 may use another subset of power amplifiers to feed the signal to another subset of the antenna elements while refraining to use the subset of power amplifiers.

When the temperature of the subset of components 308 or the transmitter circuit(s) 302 is less than (or equal) to the temperature threshold, the sensor hub 304 and/or modem 306 may determine to use the subset of components or the transmitter circuit(s) 302 for normal operations, for example, without the threshold operating temperature mitigation techniques as described herein. As an example, the sensor hub 304 may provide, to the modem 306, an indication of one or more second actions to perform in response to a temperature (e.g., an instantaneous temperature or statistical temperature) associated with a subset of the components 308 being less than or equal to the temperature threshold. The modem 306 may perform the second action(s) based on the indication. For example, the modem 306 may use at least the subset of components 308 to output a signal for transmission based on the temperature associated with the subset of the components 308 being less than or equal to the temperature threshold.

In certain aspects, the sensor hub 304 may provide, to the modem 306, temperature information (e.g., instantaneous or statistical operating temperature(s)) associated with the transmitter circuit(s) 302 and/or the plurality of components 308. Then, the modem 306 may determine the action(s), such as the first action(s) or second action(s), to perform based on the temperature information as discussed above.

FIG. 3B depicts another example thermal management architecture 300B for a wireless communications device, such as the first wireless device of FIGS. 1 and 2. In this example, the architecture 300B may include the transmitter circuit(s) 302 and the modem 306, for example, as described herein with respect to FIG. 3A.

The transmitter circuit(s) 302 may be in communication with the modem 306 without a sensor hub (such as the sensor hub 304). The transmitter circuit(s) 302 may monitor, for each of the plurality of components 308, the temperature of the respective component over time, for example, periodically or at varying time intervals. In certain cases, the transmitter circuit(s) 302 may identify which component(s) 308 are available and/or unavailable for transmission. In certain aspects, a component 308 is available for transmission based on the temperature associated with the component 308 being less than (or equal to) a temperature threshold, and the respective component 308 is unavailable for transmission based on the temperature associated with the component being greater than (or equal) to the temperature threshold. In certain aspects, the transmitter circuit(s) 302 may treat certain component(s) 308 as being unavailable for transmission to hold such components 308 in reserve for a future transmission. For example, the transmitter circuit(s) 302 may cycle through over a time period a subset of components 308 as being available while holding another subset of components 308 in reserve (e.g., unavailable) for the time period. Then, in another instance of the time period, the transmitter circuit(s) 302 may change which components 308 are available and unavailable for transmission.

The transmitter circuit(s) 302 may disable or enable certain component(s) of the plurality of components 308 depending on the respective temperature of the components. For example, the transmitter circuit(s) 302 may temporarily turn off or disable a subset of the components 308 to prevent or mitigate overheating. The transmitter circuit(s) 302 may provide, to the modem 306, an indication of which components 308 are available for transmission and/or which components 308 are disabled (e.g., unavailable for transmission). In certain cases, the transmitter circuit(s) 302 may provide, to the modem 306, the availability information associated with the components 308 periodically and/or at varying time intervals. As an example, the transmitter circuit(s) may provide, to the modem 306, the availability information associated with the components 308 at a first time occasion, and then, the transmitter circuit(s) may provide, to the modem 306, updated availability information associated with the components 308 at a second time occasion, which may occur after the first time occasion. The modem 306 may obtain, for each of the plurality of components 308, an indication of whether a respective component 308 is available for transmission based at least in part on a temperature associated with the respective component 308. The modem 306 may use the availability information to effectively re-shape the antenna array and re-allocate RF circuitry resources, accordingly. Re-shaping the antenna array may involve using a specific set of antenna elements of the antenna array for transmission, such as a particular subset of the antenna array elements as further described herein with respect to FIG. 4. The modem 306 may use the availability information to adjust the beamforming used for a transmission. For example, the modem 306 may use a set of the plurality of components 308 available for transmission to output a signal.

In certain aspects, the transmitter circuit(s) 302 may provide, to the modem 306, an indication of the first action(s) to perform in response to a temperature associated with a subset of the components 308 being greater than (or equal to) a temperature threshold, for example, as described herein with respect to FIG. 3A. In certain aspects, the transmitter circuit(s) 302 may provide, to the modem 306, an indication of the second action(s) to perform in response to a temperature (e.g., an instantaneous temperature or statistical temperature) associated with a subset of the components 308 being less than or equal to the temperature threshold, for example, as described herein with respect to FIG. 3A. In certain aspects, the transmitter circuit(s) 302 may provide, to the modem 306, temperature information (e.g., instantaneous or statistical operating temperature(s)) associated with the transmitter circuit(s) and/or the plurality of components. Then, the modem 306 may determine the action(s), such as the first action(s) or second action(s), to perform based on the temperature information as discussed above. Accordingly, the thermal management may enable reliable data rates, reliable latencies, and/or increased operating life of the transmitter circuit(s) 302.

FIG. 4 depicts an example RFIC 402 coupled to antenna array 404. The antenna array 404 may be packaged in a module in some configurations, for example by itself or in combination with the RFIC 402. In the example illustrated in FIG. 4, the RFIC 402 may include a transmit chain (such as the transmit path 218) having an array of phase shifters and an array of amplifiers. The RFIC 402 may be an example of a transmitter circuit 302 of FIG. 3. The antenna array 404 may include a plurality of antenna elements 406 arranged in a uniform linear array (as depicted), a uniform rectangular array, any suitable uniformly spaced array, or the like. The array of amplifiers may be an example of an array of power amplifiers, such as the PA 230 of FIG. 2. Accordingly, the array of phase shifters and the array of amplifiers may form an array of transmit paths for beamformed transmissions. The array of phase shifters may be arranged in different regions across the RFIC in multiple subsets of phase shifters 408a-d, and likewise, the array of amplifiers may be arranged in different regions across the RFIC in multiple subsets of amplifiers 410a-d. A subset of amplifiers 410a-d may include one or more amplifiers. In certain cases, a subset of amplifiers 410a-d may be an example of a subset of components of the plurality of components 308 as described herein with respect to FIGS. 3A and 3B.

Such an arrangement of the subset of amplifiers 410a-d across the RFIC 402 may enable the RFIC 402 to distribute and/or isolate the heat output by each of the subsets of amplifiers 410a-d. For example, due to the physical separation between the first subset of amplifiers 410a and the second subset of amplifiers 410b, the first subset of amplifiers 410a may be able to cool down (e.g., lower its temperature) while disabled when the second subset of amplifiers 410b (or any of the other subsets) is enabled or used for transmission.

In a transmit mode, an RF signal (for example, in a sub-THz frequency band) may be fed (for example, via one or more mixers, not shown) to the array of phase shifters. Each of the phase shifters may apply a certain phase shift to the RF signal and feed the respective phase shifted RF signal to an amplifier of the array of amplifiers. Each of the amplifiers may apply a specific level of gain to the RF signals. The amplifiers may feed the RF signal to antenna elements of the antenna array. Each of the amplifiers may be coupled to a different antenna element of the antenna array. As an example, the first subset of amplifiers 410a may be coupled to a subset of the antenna elements 412. Accordingly, the array of phase shifters and the array of amplifiers may be used to perform analog beamforming.

In certain aspects, the techniques for thermal management described herein may be applied to the amplifiers of the RFIC 402. As an example, a modem may adjust the transmit power applied to the amplifiers, adjust the transmit duty cycle applied to the amplifiers, and/or reallocate the antenna elements used for transmission. In certain cases, the modem may refrain from using a subset of the amplifiers (such as the first subset of amplifiers 410a) for transmission while using another subset of the amplifiers (such as 410b-d) for transmission. In turn, the modem may reallocate the antenna elements used for transmission to effectively re-shape the antenna array 404 for transmission. For example, the modem may refrain from using the subset of antenna elements 412 coupled to the first subset of amplifiers 410a for transmission, while using the remaining antenna elements 406 of the antenna array 404.

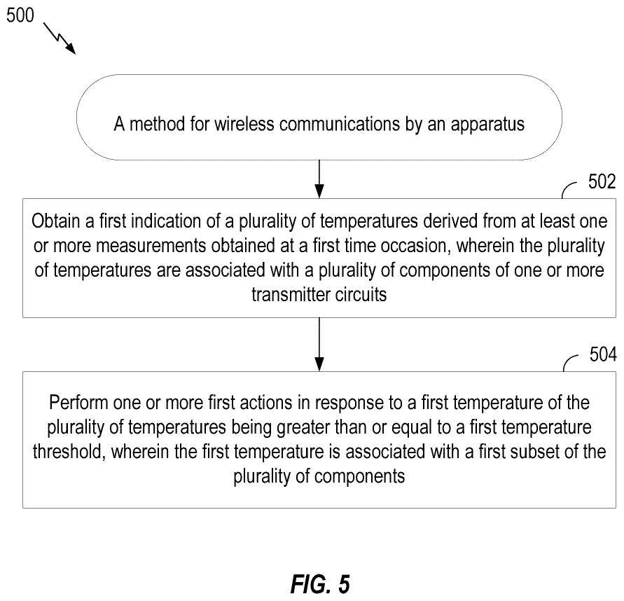

FIG. 5 illustrates example operations 500 for wireless communications. The operations 500 may be performed by an apparatus, such as a wireless device (e.g., the first wireless device 102) having the architecture 300A of FIG. 3A. The operations 500 may be implemented as software components that are executed and run on one or more processors (e.g., the modem 210 and/or the processor 212 of FIG. 2). Further, the transmission and/or reception of signals by the wireless device in the operations 500 may be enabled, for example, by one or more antennas (e.g., the antenna 220 of FIG. 2). In certain aspects, the transmission and/or reception of signals by the wireless device may be implemented via a bus interface of one or more processors (e.g., the modem 210 and/or the processor 212 of FIG. 2) obtaining and/or outputting signals for reception or transmission.

The operations 500 may optionally begin, at block 502, where the wireless device may obtain a first indication of a plurality of temperatures derived from at least one or more measurements obtained at a first time occasion, wherein the plurality of temperatures are associated with a plurality of components (e.g., the component 308) of one or more transmitter circuits (e.g., the transmitter circuit(s) 302 or the RFIC 402).

At block 504, the wireless device may perform one or more first actions in response to a first temperature of the plurality of temperatures being greater than or equal to a first temperature threshold, wherein the first temperature is associated with a first subset of the plurality of components (e.g., the first subset of amplifiers 410a). In certain aspects, the wireless device may output a signal in a sub-THz frequency band above 90 gigahertz. For example, the wireless device may transmit the signal to another wireless communication device (e.g., any of the second wireless devices 104 depicted in FIG. 1). The signal may indicate (or carry) any of various information, such as data and/or control information. In some cases, the signal may indicate (or carry) one or more packets or data blocks.

In certain aspects, performing the one or more first actions comprises decreasing a transmit power applied to at least the first subset of the plurality of components.

In certain aspects, performing the one or more first actions comprises adjusting a transmit duty cycle applied to at least the first subset of the plurality of components.

In certain aspects, the first subset of the plurality of components comprises a first set of amplifiers, and a second subset of the plurality of components comprises a second set of amplifiers. In certain aspects, performing the one or more first actions comprises feeding a signal to a first subset of antenna elements via the second set of amplifiers, wherein the first subset of antenna elements are coupled to the second set of amplifiers.

In certain aspects, the first set of amplifiers is coupled to a second subset of antenna elements. In certain aspects, performing the one or more first actions comprises feeding the signal to the first subset of antenna elements while refraining to use the first set of amplifiers.

In certain aspects, the wireless device may perform one or more second actions in response to a second temperature of the plurality of temperatures being less than the first temperature threshold. In certain aspects, performing the one or more second actions may comprise outputting the signal using at least one transmitter circuit of the one or more transmitter circuits, wherein the second temperature is associated with the at least one transmitter circuit.

In certain aspects, obtaining the first indication of the plurality of temperatures comprises obtaining the first indication of the plurality of temperatures via a sensor hub. In certain aspects, the apparatus may include one or more processors, coupled to the sensor hub. The processor(s) may obtain, from the sensor hub, a second indication of the one or more first actions, and the processor(s) may perform the one or more first actions based on the second indication.

In certain aspects, obtaining the first indication of the plurality of temperatures comprises obtaining the first indication of the plurality of temperatures via a sensor hub coupled to the one or more transmitter circuits. In certain aspects, the apparatus may include one or more processors, coupled to the sensor hub. The processor(s) may obtain, from the sensor hub, a second indication of the one or more first actions, and the processor(s) may perform the one or more first actions based on the second indication.

In certain aspects, the plurality of components comprises a plurality of amplifiers arranged in an array of transmit paths; and the first temperature is associated with a first subset of the plurality of amplifiers.

In certain aspects, the plurality of components comprises a plurality of radio frequency integrated circuits, and the first temperature is associated with a first radio frequency integrated circuit of the plurality of radio frequency integrated circuits.

In certain aspects, the first temperature includes one or more of an average temperature, a peak temperature, or a minimum temperature over a moving time window.

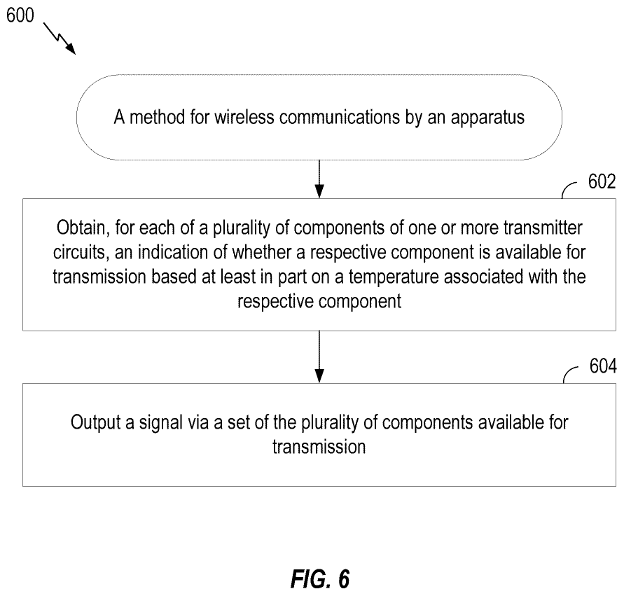

FIG. 6 illustrates example operations 600 for wireless communication. The operations 600 may be performed by an apparatus, such as a wireless device (e.g., the first wireless device 102) having the architecture 300B of FIG. 3B.

The operations 600 may optionally begin, at block 602, where the wireless device may obtain, for each of a plurality of components of one or more transmitter circuits, an indication of whether a respective component is available for transmission based at least in part on a temperature associated with the respective component

At block 604, the wireless device may output a signal via a set of the plurality of components available for transmission. For example, the wireless device may transmit the signal to another wireless communications device (e.g., any of the second wireless devices 104 depicted in FIG. 1). The signal may indicate (or carry) any of various information, such as data and/or control information. In some cases, the signal may indicate (or carry) one or more packets or data blocks.

In certain aspects, the plurality of components comprises a first set of amplifiers and a second set of amplifiers, wherein a plurality of amplifiers arranged in an array of transmit paths comprises the first set of amplifiers and the second set of amplifiers.

In certain aspects, the plurality of components comprises a plurality of radio frequency integrated circuits.

In certain aspects, outputting the signal comprises outputting the signal in a sub-terahertz frequency band above 90 gigahertz.

In certain aspects, the wireless device may monitor, for each of the plurality of components, the temperature of the respective component; and provide, for each of the plurality of components, the indication of whether the respective components is available for transmission, wherein the respective component is available for transmission based on the temperature being less than a temperature threshold, and wherein the respective component is unavailable for transmission based on the temperature being greater than or equal to the temperature threshold.

Aspects of the present disclosure may be applied to any of various wireless communications devices that may perform thermal management described herein, such as a user equipment, wireless station, base station, access point, or the like.

### Example Communications Device

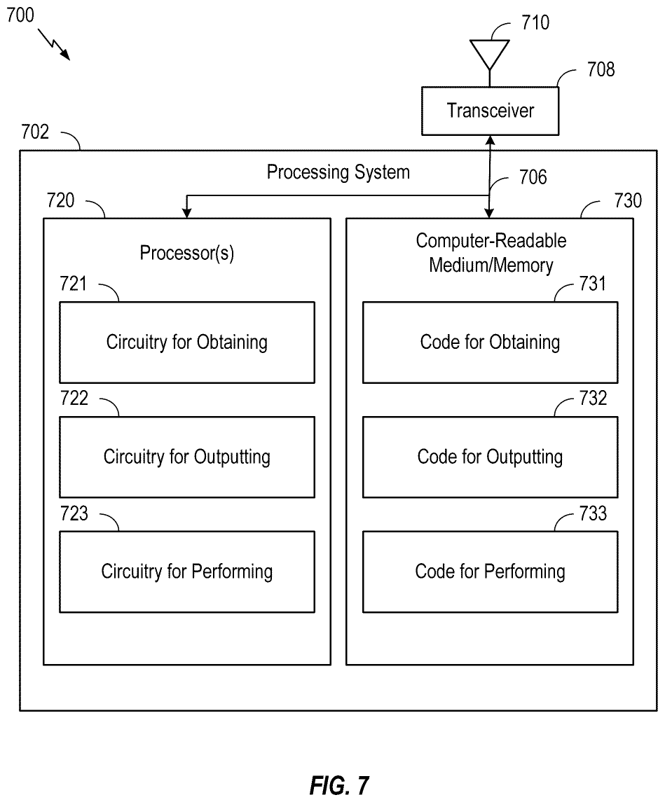

FIG. 7 depicts aspects of an example communications device 700. In some aspects, communications device 700 is a wireless communication device, such as the first wireless device 102 described above with respect to FIGS. 1 and 2.

The communications device 700 includes a processing system 702 coupled to a transceiver 708 (e.g., a transmitter and/or a receiver). The transceiver 708 is configured to transmit and receive signals for the communications device 700 via an antenna 710, such as the various signals described herein. The processing system 702 may be configured to perform processing functions for the communications device 700, including processing signals received and/or to be transmitted by the communications device 700.

The processing system 702 includes one or more processors 720. In various aspects, the one or more processors 720 may be representative of any of the modem 210 and/or the processor 212, as described with respect to FIG. 2. The one or more processors 720 are coupled to a processor-readable medium/memory 730 via a bus 706. In certain aspects, the processor-readable medium/memory 730 is configured to store instructions (e.g., processor-executable code) that when executed by the one or more processors 720, cause the one or more processors 720 to perform the operations 500 described with respect to FIG. 5, the operations 600 described with respect to FIG. 6, or any aspect related to the operations described herein. Note that reference to a processor performing a function of communications device 700 may include one or more processors performing that function of communications device 700. Reference to one or more processors performing multiple functions may include any one of the one or more processors performing any one of the multiple functions.

In the depicted example, processor-readable medium/memory 730 stores code (e.g., executable instructions) for obtaining 731, code for outputting 732, code for performing 733, or any combination thereof. Processing of the code 731-733 may cause the communications device 700 to perform the operations 500 described with respect to FIG. 5, the operations 600 described with respect to FIG. 6, or any aspect related to operations described herein.

The one or more processors 720 include circuitry configured to implement (e.g., execute) the code stored in the processor-readable medium/memory 730, including circuitry for obtaining 721, circuitry for outputting 722, circuitry for performing 723, or any combination thereof. Processing with circuitry 721-723 may cause the communications device 700 to perform the operations 500 described with respect to FIG. 5, the operations 600 described with respect to FIG. 6, or any aspect related to operations described herein.

Various components of the communications device 700 may provide means for performing the operations 500 described with respect to FIG. 5, the operations 600 described with respect to FIG. 6, or any aspect related to operations described herein. For example, means for transmitting, sending or outputting for transmission may include the TX path 218 and/or antenna(s) 220 of the first wireless device 102 illustrated in FIG. 2 and/or transceiver 708 and antenna 710 of the communications device 700 in FIG. 7. Means for receiving or obtaining may include the RX path 222 and/or antenna(s) 220 of the first wireless device illustrated in FIG. 2 and/or transceiver 708 and antenna 710 of the communications device 700 in FIG. 7. Means for performing action(s) may include one or more processors, such as the modem 210 and/or processor 212 depicted in FIG. 2 and/or the processor(s) 720 in FIG. 7.

### EXAMPLE ASPECTS

Implementation examples are described in the following numbered clauses:

Aspect 1: An apparatus configured for wireless communications, comprising: one or more transmitter circuits configured to output a signal for transmission, wherein the one or more transmitter circuits comprise a plurality of components; and one or more circuits configured to cause the apparatus to: obtain a first indication of a plurality of temperatures derived from at least one or more measurements obtained at a first time occasion, wherein the plurality of temperatures are associated with the plurality of components; and perform one or more first actions in response to a first temperature of the plurality of temperatures being greater than or equal to a first temperature threshold, wherein the first temperature is associated with a first subset of the plurality of components.

Aspect 2: The apparatus of Aspect 1, wherein the one or more transmitter circuits are configured to output the signal in a sub-terahertz frequency band above 90 gigahertz.

Aspect 3: The apparatus of Aspect 1 or 2, wherein to perform the one or more first actions, the one or more circuits are configured to cause the apparatus to decrease a transmit power applied to at least the first subset of the plurality of components.

Aspect 4: The apparatus according to any of Aspects 1-3, wherein to perform the one or more first actions, the one or more circuits are configured to cause the apparatus to adjust a transmit duty cycle applied to at least the first subset of the plurality of components.

Aspect 5: The apparatus according to any of Aspects 1-4, wherein: the first subset of the plurality of components comprises a first set of amplifiers; a second subset of the plurality of components comprises a second set of amplifiers; and to perform the one or more first actions, the one or more circuits are configured to cause the apparatus to feed the signal to a first subset of antenna elements via the second set of amplifiers, wherein the first subset of antenna elements are coupled to the second set of amplifiers.

Aspect 6: The apparatus of Aspect 5, wherein: the first set of amplifiers is coupled to a second subset of antenna elements; and to perform the one or more first actions, the one or more circuits are configured to cause the apparatus to feed the signal to the first subset of antenna elements while refraining to use the first set of amplifiers.

Aspect 7: The apparatus according to any of Aspects 1-6, wherein the one or more circuits are configured to cause the apparatus to perform one or more second actions in response to a second temperature of the plurality of temperatures being less than the first temperature threshold.

Aspect 8: The apparatus of Aspect 7, wherein to perform the one or more second actions, the one or more circuits are configured to cause the apparatus to output the signal using at least one transmitter circuit of the one or more transmitter circuits, wherein the second temperature is associated with the at least one transmitter circuit.

Aspect 9: The apparatus according to any of Aspects 1-8, wherein the one or more circuits comprise: a sensor hub, coupled to the one or more transmitter circuits, configured to obtain the first indication of the plurality of temperatures; and one or more processors, coupled to the sensor hub, configured to cause the apparatus to: obtain, from the sensor hub, a second indication of the one or more first actions; and perform the one or more first actions based on the second indication.

Aspect 10: The apparatus according to any of Aspects 1-9, wherein: the plurality of components comprises a plurality of amplifiers arranged in an array of transmit paths; and the first temperature is associated with a first subset of the plurality of amplifiers.

Aspect 11: The apparatus according to any of Aspects 1-10, wherein: the plurality of components comprises a plurality of radio frequency integrated circuits, and the first temperature is associated with a first radio frequency integrated circuit of the plurality of radio frequency integrated circuits.

Aspect 12: The apparatus according to any of Aspects 1-11, wherein the first temperature includes one or more of an average temperature, a peak temperature, or a minimum temperature over a moving time window.

Aspect 13: An apparatus configured for wireless communications, comprising: one or more transmitter circuits configured to output at least one signal for transmission, wherein the one or more transmitter circuits comprise a plurality of components; one or more processors coupled to the one or more transmitter circuits, the one or more processors being configured to cause the apparatus to: obtain, for each of the plurality of components, an indication of whether a respective component is available for transmission based at least in part on a temperature associated with the respective component; and output the signal via a set of the plurality of components available for transmission.

Aspect 14: The apparatus of Aspect 13, wherein the plurality of components comprises a first set of amplifiers and a second set of amplifiers, wherein a plurality of amplifiers arranged in an array of transmit paths comprises the first set of amplifiers and the second set of amplifiers.

Aspect 15: The apparatus of Aspect 13 or 14, wherein the plurality of components comprises a plurality of radio frequency integrated circuits.

Aspect 16: The apparatus according to any of Aspects 13-15, wherein the one or more transmitter circuits are configured to output the at least one signal in a sub-terahertz frequency band above 90 gigahertz.

Aspect 17: The apparatus according to any of Aspects 13-16, wherein the one or more transmitter circuits are configured to: monitor, for each of the plurality of components, the temperature of the respective component; and provide, for each of the plurality of components, the indication of whether the respective components is available for transmission, wherein the respective component is available for transmission based on the temperature being less than a temperature threshold, and wherein the respective component is unavailable for transmission based on the temperature being greater than or equal to the temperature threshold.

Aspect 18: A method for wireless communications by an apparatus, comprising: obtaining a first indication of a plurality of temperatures derived from at least one or more measurements obtained at a first time occasion, wherein the plurality of temperatures are associated with a plurality of components of one or more transmitter circuits; and performing one or more first actions in response to a first temperature of the plurality of temperatures being greater than or equal to a first temperature threshold, wherein the first temperature is associated with a first subset of the plurality of components.

Aspect 19: The method of Aspect 18, wherein performing the one or more first actions comprises outputting a signal in a sub-terahertz frequency band above 90 gigahertz.

Aspect 20: The method of Aspect 18 or 19, wherein performing the one or more first actions comprises decreasing a transmit power applied to at least the first subset of the plurality of components.

Aspect 21: The method according to any of Aspects 18-20, wherein performing the one or more first actions comprises adjusting a transmit duty cycle applied to at least the first subset of the plurality of components.

Aspect 22: The method according to any of Aspects 18-21, wherein: the first subset of the plurality of components comprises a first set of amplifiers; a second subset of the plurality of components comprises a second set of amplifiers; and performing the one or more first actions comprises feeding a signal to a first subset of antenna elements via the second set of amplifiers, wherein the first subset of antenna elements are coupled to the second set of amplifiers.

Aspect 23: The method of Aspect 22, wherein: the first set of amplifiers is coupled to a second subset of antenna elements; and performing the one or more first actions comprises feeding the signal to the first subset of antenna elements while refraining to use the first set of amplifiers.

Aspect 24: The method according to any of Aspects 18-23, further comprising performing one or more second actions in response to a second temperature of the plurality of temperatures being less than the first temperature threshold.

Aspect 25: The method of Aspect 24, wherein performing the one or more second actions comprises outputting a signal using at least one transmitter circuit of the one or more transmitter circuits, wherein the second temperature is associated with the at least one transmitter circuit.

Aspect 26: The method according to any of Aspects 18-25, wherein: obtaining the first indication of the plurality of temperatures comprises obtaining the first indication of the plurality of temperatures via a sensor hub coupled to the one or more transmitter circuits; the method further comprises obtaining, from the sensor hub, a second indication of the one or more first actions; and performing the one or more first actions comprises performing the one or more first actions based on the second indication.

Aspect 27: The method according to any of Aspects 18-26, wherein: the plurality of components comprises a plurality of amplifiers arranged in an array of transmit paths; and the first temperature is associated with a first subset of the plurality of amplifiers.

Aspect 28: The method according to any of Aspects 18-27, wherein: the plurality of components comprises a plurality of radio frequency integrated circuits, and the first temperature is associated with a first radio frequency integrated circuit of the plurality of radio frequency integrated circuits.

Aspect 29: The method according to any of Aspects 18-28, wherein the first temperature includes one or more of an average temperature, a peak temperature, or a minimum temperature over a moving time window.

Aspect 30: A method for wireless communications by an apparatus, comprising: obtaining, for each of a plurality of components of one or more transmitter circuits, an indication of whether a respective component is available for transmission based at least in part on a temperature associated with the respective component; and outputting a signal via a set of the plurality of components available for transmission.

Aspect 31: The method of Aspect 30, wherein the plurality of components comprises a first set of amplifiers and a second set of amplifiers, wherein a plurality of amplifiers arranged in an array of transmit paths comprises the first set of amplifiers and the second set of amplifiers.

Aspect 32: The method of Aspect 30 or 31, wherein the plurality of components comprises a plurality of radio frequency integrated circuits.

Aspect 33: The method according to any of Aspects 30-32, wherein outputting the signal comprises outputting the signal in a sub-terahertz frequency band above 90 gigahertz.

Aspect 34: The method according to any of Aspects 30-33, further comprising: monitoring, for each of the plurality of components, the temperature of the respective component; and providing, for each of the plurality of components, the indication of whether the respective components is available for transmission, wherein the respective component is available for transmission based on the temperature being less than a temperature threshold, and wherein the respective component is unavailable for transmission based on the temperature being greater than or equal to the temperature threshold.

Aspect 35: An apparatus, comprising: a memory; and one or more processors configured to perform a method in accordance with any of Aspects 18-34.

Aspect 36: An apparatus, comprising means for performing a method in accordance with any of Aspects 18-34.

Aspect 37: A non-transitory computer-readable medium comprising computer-executable instructions that, when executed by one or more processors of a processing system, cause the processing system to perform a method in accordance with any of Aspects 18-34.

Aspect 38: A computer program product embodied on a computer-readable storage medium comprising code for performing a method in accordance with any of Aspects 18-34.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general purpose processor, an artificial intelligence (AI) processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), a system in package (SiP), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining or the like. Also, “determining” may include receiving (e.g., receiving information), accessing (e.g., accessing data in a memory) or the like. Also, “determining” may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

1. An apparatus configured for wireless communications, comprising:
one or more transmitter circuits configured to output a signal for transmission, wherein the one or more transmitter circuits comprise a plurality of components; and
one or more circuits configured to cause the apparatus to:
obtain a first indication of a plurality of temperatures derived from at least one or more measurements obtained at a first time occasion, wherein the plurality of temperatures are associated with the plurality of components; and
perform one or more first actions in response to a first temperature of the plurality of temperatures being greater than or equal to a first temperature threshold, wherein the first temperature is associated with a first subset of the plurality of components.

2. The apparatus of claim 1, wherein the one or more transmitter circuits are configured to output the signal in a sub-terahertz frequency band above 90 gigahertz.

3. The apparatus of claim 1, wherein to perform the one or more first actions, the one or more circuits are configured to cause the apparatus to decrease a transmit power applied to at least the first subset of the plurality of components.

4. The apparatus of claim 1, wherein to perform the one or more first actions, the one or more circuits are configured to cause the apparatus to adjust a transmit duty cycle applied to at least the first subset of the plurality of components.

5. The apparatus of claim 1, wherein:
the first subset of the plurality of components comprises a first set of amplifiers;
a second subset of the plurality of components comprises a second set of amplifiers; and
to perform the one or more first actions, the one or more circuits are configured to cause the apparatus to feed the signal to a first subset of antenna elements via the second set of amplifiers, wherein the first subset of antenna elements are coupled to the second set of amplifiers.

6. The apparatus of claim 5, wherein:
the first set of amplifiers is coupled to a second subset of antenna elements; and
to perform the one or more first actions, the one or more circuits are configured to cause the apparatus to feed the signal to the first subset of antenna elements while refraining to use the first set of amplifiers.

7. The apparatus of claim 1, wherein the one or more circuits are configured to cause the apparatus to perform one or more second actions in response to a second temperature of the plurality of temperatures being less than the first temperature threshold.

8. The apparatus of claim 7, wherein to perform the one or more second actions, the one or more circuits are configured to cause the apparatus to output the signal using at least one transmitter circuit of the one or more transmitter circuits, wherein the second temperature is associated with the at least one transmitter circuit.

9. The apparatus of claim 1, wherein the one or more circuits comprise:
a sensor hub, coupled to the one or more transmitter circuits, configured to obtain the first indication of the plurality of temperatures; and
one or more processors, coupled to the sensor hub, configured to cause the apparatus to:
obtain, from the sensor hub, a second indication of the one or more first actions; and
perform the one or more first actions based on the second indication.

10. The apparatus of claim 1, wherein:
the plurality of components comprises a plurality of amplifiers arranged in an array of transmit paths; and
the first temperature is associated with a first subset of the plurality of amplifiers.

11. The apparatus of claim 1, wherein:
the plurality of components comprises a plurality of radio frequency integrated circuits, and
the first temperature is associated with a first radio frequency integrated circuit of the plurality of radio frequency integrated circuits.

12. The apparatus of claim 1, wherein the first temperature includes one or more of an average temperature, a peak temperature, or a minimum temperature over a moving time window.

13. An apparatus configured for wireless communications, comprising:
one or more transmitter circuits configured to output at least one signal for transmission, wherein the one or more transmitter circuits comprise a plurality of components;
one or more processors coupled to the one or more transmitter circuits, the one or more processors being configured to cause the apparatus to:
obtain, for each of the plurality of components, an indication of whether a respective component is available for transmission based at least in part on a temperature associated with the respective component; and
output the signal via a set of the plurality of components available for transmission.

14. The apparatus of claim 13, wherein the plurality of components comprises a first set of amplifiers and a second set of amplifiers, wherein a plurality of amplifiers arranged in an array of transmit paths comprises the first set of amplifiers and the second set of amplifiers.

15. The apparatus of claim 13, wherein the plurality of components comprises a plurality of radio frequency integrated circuits.

16. The apparatus of claim 13, wherein the one or more transmitter circuits are configured to output the at least one signal in a sub-terahertz frequency band above 90 gigahertz.

17. The apparatus of claim 13, wherein the one or more transmitter circuits are configured to:
monitor, for each of the plurality of components, the temperature of the respective component; and
provide, for each of the plurality of components, the indication of whether the respective components is available for transmission, wherein the respective component is available for transmission based on the temperature being less than a temperature threshold, and wherein the respective component is unavailable for transmission based on the temperature being greater than or equal to the temperature threshold.

18. A method for wireless communications by an apparatus, comprising:
obtaining a first indication of a plurality of temperatures derived from at least one or more measurements obtained at a first time occasion, wherein the plurality of temperatures are associated with a plurality of components of one or more transmitter circuits; and
performing one or more first actions in response to a first temperature of the plurality of temperatures being greater than or equal to a first temperature threshold, wherein the first temperature is associated with a first subset of the plurality of components.

19. The method of claim 18, wherein performing the one or more first actions comprises decreasing a transmit power applied to at least the first subset of the plurality of components.

20. The method of claim 18, wherein performing the one or more first actions comprises adjusting a transmit duty cycle applied to at least the first subset of the plurality of components.
